(19) United States
(12) Patent Application Publication
(10) Pub. No.: US 2026/0266646 A1
(43) Pub. Date: Sep. 10, 2026

(54) APPARATUS FOR MONITORING THE FILL LEVEL OF FILLED CONTAINERS

(71) Applicant: KRONES AG, Neutraubling (DE)

(72) Inventor: Judith MENGELKAMP, Obertraubling (DE)

(21) Appl. No.: 18/873,276

(22) PCT Filed: Mar. 30, 2023
(86) PCT No.: PCT/EP2023/058388

§ 371 Date: Dec. 9, 2024

(30) Foreign Application Priority Data
Jun. 9, 2022 (DE) 10 2022 114 578.6

(51) Int. Cl. G01F 23/263; G01F 23/292

(52) U.S. Cl. CPC G01F 23/263; G01F 23/292

(57) ABSTRACT

An apparatus for monitoring the fill level of filled containers has an inspection device for inspecting the containers transported by the transport device, wherein the inspection device has a first transmission device which outputs a high-frequency transmission signal and a first receiving device which receives the signal output by the first transmission device or a signal based upon the signal output by the first transmission device, and a second transmission device which outputs a high-frequency transmission signal and a second receiving device which receives the signal output by the second transmission device or a signal based upon the signal output by the second transmission device, wherein the second transmission device is arranged in an offset manner in a longitudinal direction of the containers to be inspected relative to the first transmission device, and the second receiving device is arranged in an offset manner in a longitudinal direction of the containers to be inspected relative to the first receiving device.

### DESCRIPTION

The present invention relates to an apparatus and a method for monitoring the fill level of filled containers. In the beverage manufacturing industry, it is known to produce containers, then fill and seal and finally transport them further. In one process step, it is necessary to check whether the containers have been filled correctly. Underfilled containers will be complained about by the customer.

It is known from the prior art that containers are transported and, during this transport, the fill level of the liquid in the containers is monitored—for example, by means of light barriers or optically. The disadvantage of this approach is that the liquid is often obscured by the labels or printing applied to the containers. This also applies to fill-level monitoring based upon imaging techniques such as matrix or line scan cameras. In addition, such methods are also expensive and complex.

It is known from the prior art to use high-frequency signals to monitor the fill level, wherein the container with the liquid therein develops different capacitances (depending upon the fill level), which in turn have different effects in an electric field between a transmission and a receiving device.

Furthermore, methods are also known from the prior art which use ionizing radiation such as beta and gamma radiation. However, such methods are safety-critical due to the employed radiation.

WO 2006/087069 A1 discloses a method and an apparatus for fill-level measurement. Measuring beams are used to which the containers are transparent.

There is still the problem that the same apparatus for monitoring the fill-level monitoring has to handle different size containers and possibly also significantly different fill levels.

The present invention is therefore based upon the object of more efficiently configuring such apparatuses and methods for fill-level monitoring. According to the invention, this is achieved by the subject matter of the independent claims. Advantageous embodiments and developments are the subject matter of the dependent claims.

An apparatus according to the invention for monitoring the fill level of filled containers has a transport device which transports the containers along a predetermined transport path and at least one inspection device for inspecting the containers transported by the transport device. The inspection device has a first transmission device which outputs a high-frequency transmission signal and a first receiving device which receives the signal output by the first transmission device and/or a signal based upon this signal output by the first transmission device. Furthermore, the transport path of the containers runs—preferably in a single lane—between the transmission device and the receiving device.

According to the invention, the inspection device has a second transmission device which outputs a high-frequency transmission signal and a second receiving device which receives the signal output by the second transmission device and/or a signal based upon this signal output by the second transmission device, wherein the second transmission device is arranged in an offset manner in a longitudinal direction of the containers to be inspected relative to the first transmission device (and in particular a vertical direction), and the second receiving device is arranged in an offset manner in a longitudinal direction of the containers to be inspected relative to the first receiving device (and in particular a vertical direction).

Preferably, the first and the second transmission device on the one hand and the first receiving device and the second receiving device on the other hand are arranged one above the other. These devices can also be arranged diagonally one above the other, but they are preferably arranged one above the other in a vertical direction.

Preferably, at least one transmission device outputs, and preferably both transmission devices output, transmission frequencies which lie in a frequency range that is between 30 kHz and 300 GHz. Particularly preferably, the frequencies lie between 30 kHz and 10 MHz.

Particularly preferably, each receiving device is assigned to exactly one transmission device. Therefore, pairs of transmission and receiving devices are preferably formed. These pairs are particularly preferably controllable independently of each other.

In a further advantageous embodiment, the apparatus has a position detection device which is arranged in particular in front of the inspection device. Preferably, the position detection device is a light barrier which particularly preferably triggers a measurement and in particular a fill-level inspection. In a further preferred embodiment, at least one transmission device and the receiving device and preferably several transmission devices and receiving devices are designated to carry out continuous measurements.

Particularly preferably, the transmission devices have transmission antennas (which are configured in particular as transmission surfaces). Particularly preferably, the receiving devices have reception surfaces. This is advantageous when working with transmission frequencies of up to several hundred MHz.

Furthermore, waveguides with horn antennas can also be used as transmission devices. This is in particular suitable for even higher transmission frequencies.

In a further advantageous embodiment, the apparatus has at least one further fill-level measuring device and in particular a fill-level measuring device which works with a different physical principle than the fill-level monitoring described here. For example, this further fill-level measuring device can have an image recording device such as a camera or one or more light barriers. Preferably, the further fill-level measuring device is a fill-level measuring device which uses a spatially resolving measuring method.

Preferably, the further fill-level measuring device is a measuring device which uses infrared light or infrared radiation.

Preferably, this further measuring device, which is in particular an infrared measuring device, is also arranged such that it measures transversely and in particular perpendicularly to the transport device of the containers, and/or the signal direction of the infrared signal runs transversely and in particular perpendicularly to the transport direction.

Particularly preferably, this second fill-level measuring device, which is in particular an infrared fill-level measuring device, also has at least two and preferably at least three infrared emitters and/or infrared receivers, which are particularly preferably arranged at different heights.

In a further preferred embodiment, the at least two different fill-level measuring devices are integrated into the same housing. This housing is preferably formed in one piece and in particular welded or milled.

In a preferred embodiment, at least one HF transmission device and one IR transmission device are arranged in a leg of this housing. Preferably, at least one HF receiving device and one IR receiving device are arranged in a second leg of this housing.

Preferably, at least two, preferably at least three, HF transmission devices and/or at least two, preferably at least three, IR transmission devices are arranged in a leg of the housing.

Preferably, at least two, preferably at least three, HF receiving devices and/or at least two, preferably at least three, IR receiving devices are arranged in the other leg of the housing.

An advantage of using two fill-level measuring devices is the greater accuracy of the measurement.

A further advantage of using two different fill-level measurement principles is the processing versatility. Translucent containers are accordingly preferably inspected using HF and/or infrared. Containers that are impenetrable to infrared are preferably examined using HF.

A further advantage of using two different fill-level measurement principles is that the results of the HF and IR measurements are calculated to give an overall result or fill level.

Preferably, the two different fill-level measuring devices are structured modularly. This accordingly makes it possible for a customer to select whether he wants only one of the two fill-level measuring devices and, if applicable, which one, or whether he wants both fill-level measuring devices.

In addition, it would also be possible for (at least) one HF transmission device and (at least) one IR receiving device to be arranged in the first leg of the housing, and for (at least) one IR transmission device and (at least) one HF receiving device to be arranged in the other leg of the housing.

Multi-channel, high-frequency fill-level monitoring for determining the fill level of bottled liquid media (water, juice, beer, etc.) is preferably proposed, which preferably has at least three transmitter/receiver pairs which are preferably arranged one above the other.

Preferably, a measurement is carried out by transmitting an HF signal. This preferably creates an electric field between the transmission device and the receiving device. The container in the measuring bridge changes the dielectric or the electric field. Part of the signal can be diverted to ground (for example, via the transport device). This part is preferably proportional to the fill level in the container.

In a further advantageous embodiment, the inspection device is adjustable in the longitudinal direction of the containers and/or a vertical direction. In this way, the inspection device can be adapted to different container heights.

In a further advantageous embodiment, the apparatus has an ejection device which ejects faulty containers. In particular, in this way, such containers can be ejected that are underfilled.

In a further advantageous embodiment, each transmission device is assigned exactly one receiving device such that this transmission device and the receiving device assigned thereto form a measuring section, preferably a measuring section in which an electrical value is measured and in which in particular an electric field is measurable.

In a preferred embodiment, linear (and in particular horizontally running) measuring sections are formed. Accordingly, the first transmission device and the first receiving device can form a measuring section, and the second transmission device and the second receiving device can also form a measuring section.

Alternatively, it would also be possible for the first transmission device and the second receiving device (and, vice versa, the second transmission device and the first receiving device) to form a measuring section and therefore measure crosswise.

Preferably, the first transmission device and the first receiving device are arranged at the same height. Preferably, the second transmission device and the second receiving device are arranged at the same height.

Particularly preferably, these at least two measuring sections can be activated independently of one another. Furthermore, it is possible for the transmission device to be assigned to the first receiving device and, for example, the electric field to be established and/or measured in a horizontal direction. In addition, however, the first transmission device could also be assigned to the second receiving device, wherein in this case, the transmission device and the receiving device assigned thereto are preferably arranged at different heights in the longitudinal direction of the containers.

In a further advantageous embodiment, at least one transmission device and the receiving device assigned thereto are arranged such that an electric field can be established between this transmission device and the receiving device assigned thereto, through which the containers can be transported.

With this procedure, the dielectric in the electric field is changed when the container passes through, and the fill levels can thereby be determined. This means that an electric field between the transmission and receiving device is preferably determined or measured to determine the fill level.

Preferably, the resulting electrical signal is diverted, in particular to ground—for example, via the transport device. This diverted portion is dependent and in particular linearly dependent upon and/or proportional to the fill level within the container.

Preferably, the evaluation and/or measurement is carried out from a combination of all pairs of transmission devices and receiving devices. In this way, a greater accuracy is achieved in comparison to a transmission device/receiving device pair. This therefore also makes a larger measuring range possible (for example, up to 80 mm high). In addition, a greater linearity of the measuring range can also be achieved in this way.

Preferably, the apparatus has an evaluation device which evaluates the measured signals. This evaluation is preferably suitable and intended for evaluating all measured signals (of all measuring sections and/or transmission device/receiving device pairs). Preferably, several and preferably all measuring sections are taken into account for an evaluation.

In a further advantageous embodiment, the transport path is rectilinear, and particularly preferably at least one guide device is provided for guiding the containers, which limits a movement of the containers perpendicular to the transport path. In this way, a very precise positioning of the containers perpendicular to the transport direction is achieved.

In a particularly preferred embodiment, the transport device has a conveyor belt or a conveyor chain. Advantageously, this conveyor belt or the conveyor chain forms a support surface on which the containers particularly preferably stand upright. In a further advantageous embodiment, the guide device has a lateral guide rail. Advantageously, the transport device also has a second guide rail. The containers are particularly preferably transported between the guide rails. In a further advantageous embodiment, the guide device is adjustable, and in particular adjustable in a direction perpendicular to the transport direction.

Particularly preferably, the guide devices guide the containers at their main bodies. Particularly preferably, a mouth region of the containers projects in a vertical direction beyond the guide device. Preferably, in particular the mouth areas and any necks of the containers protrude beyond the guide rails. Particularly preferably, at least the uppermost third of the containers, preferably at least the uppermost fourth of the containers, preferably at least the uppermost fifth of the containers protrude beyond the guide rails. This prevents the inspection from being disturbed by the guide devices.

The containers are preferably made of glass or plastic. In a particularly preferred embodiment, the containers are transported at a distance from one another.

Particularly preferably, a distance between two containers on the transport device is at least 20% of the container diameter, preferably at least 30% of the container diameter, preferably at least 40% of the container diameter, preferably at least 50% of the container diameter, and preferably at least 70% of the container diameter. In this way, it can be prevented that a fill-level inspection is disturbed too much by neighboring containers.

Particularly preferably, a distance between two containers on the transport device is at most 200% of the container diameter, preferably at most 150% of the container diameter, preferably at most 130% of the container diameter, preferably at most 120% of the container diameter, and preferably at most 110% of the container diameter.

In a preferred embodiment, the apparatus has a compensation device which compensates for and/or reduces influences of adjacent containers on the measurement result. For example, it is accordingly possible to take into account the influences of neighboring containers using an algorithm. This algorithm can take into account the usual signal curves that would arise for similar and/or identically filled containers.

In a further advantageous embodiment, the inspection device has at least one further transmission device which outputs a high-frequency transmission signal and at least one further receiving device which receives the signal output by the further transmission device or a signal based upon this signal output by the further transmission device, wherein the further transmission device is arranged in an offset manner in a longitudinal direction of the containers to be inspected (and in particular a vertical direction) from the first transmission device and the second transmission device, and the further receiving device is offset in the longitudinal direction of the containers to be inspected (and in particular a vertical direction) relative to the first receiving device and the second receiving device. Particularly preferably, the total of three transmission devices and/or receiving devices (and in particular also three measuring sections) are arranged one above the other in the longitudinal direction of the containers.

Particularly preferably, all transmission devices are arranged on a first side laterally next to the transport path of the containers, and all receiving devices, with respect to the transport path, are arranged on a second side opposite the first side next to the transport path. A simplification of the apparatus can thereby be achieved.

In a further advantageous embodiment, the inspection device has a bridge-like carrier on which the transmission devices and the receiving devices are arranged. This bridge-like carrier can also form a ground for the apparatus.

Particularly preferably, the transmission devices and the receiving devices are each integrated into resonant circuits.

In a further embodiment, the inspection device has at least one measuring device which measures a value characteristic of an electric field between a transmission device and the receiving device assigned thereto. This can, for example, be an electrical voltage, a current, or also a capacitance. Furthermore, it would be possible, for example, for a natural frequency of an resonant circuit to be such a characteristic value.

In a further advantageous embodiment, several transmission devices can be operated simultaneously, wherein these transmission devices can preferably be operated with different transmission frequencies. In this way, it is possible to establish different electrical fields and/or measuring sections between the transmission devices and the receiving devices without these fields interfering with each other.

In a further advantageous embodiment, the apparatus has a control device which enables time-staggered activation of several transmission devices and preferably also of the receiving devices assigned thereto. In this way, it would be possible, for example, for several transmission devices to be activated one after the other in a multiplexing method. In this way, several regions or even strongly varying fill levels can be detected in the height direction of the container.

It would be further preferable that the individual transmission devices and/or receiving devices, which are activated one after the other, are arranged one behind the other in the transport direction of the containers, in particular in order to compensate for the change in location of the containers to be inspected caused by the transport of the containers.

In a preferred embodiment, the inspection device as a whole forms a measuring range in a longitudinal direction of the containers which is larger than 2 mm, preferably larger than 4 mm, preferably larger than 6 mm and preferably larger than 7 mm, and preferably larger than 10 mm and preferably larger than 15 mm. In a further advantageous embodiment, the inspection device forms a measuring range in the longitudinal direction of the containers which is smaller than 130 mm, preferably smaller than 120 mm, preferably smaller than 110 mm, and particularly preferably smaller than 100 mm.

In a further advantageous embodiment, the apparatus has a sensor device for detecting at least one value characteristic of environmental conditions, and preferably a processor unit which takes this characteristic value into account when evaluating the measured values originating from the at least one measuring section.

Environmental conditions such as temperature, air pressure, or the like (which affect a dielectric) can also play a role in the creation of an electric field. Particularly preferably, the characteristic value is therefore a value that is selected from a group of values which includes air pressure, temperature, humidity, and the like.

In a preferred embodiment, the evaluation device is suitable and intended, in the context of the evaluation, for taking these environmental conditions into account and/or compensating for them.

Preferably, the evaluation device is suitable and intended for carrying out a (self-)calibration. Preferably, calibration during operation (in particular under changing operating conditions) is also possible.

In a further preferred embodiment, the evaluation device is suitable and intended for performing a compensation for effects which occur due to foam formation of the liquid in the container.

Preferably, an amplitude and/or a phase of a signal from the receiving device is evaluated.

In a further advantageous embodiment, a distance of the transmission device and the receiving device from each other can be changed (in particular, in a direction perpendicular to the transport path of the containers). In this way, adaptation to different container geometries can be achieved.

The present invention is further directed to a method for monitoring the fill level of containers filled (and in particular closed) (in particular with a liquid and in particular with a beverage), wherein a transport device transports the containers along a predetermined transport path, and an inspection device inspects the containers transported by the transport device, and wherein the inspection device has a first transmission device which outputs a high-frequency signal and a first receiving device which receives the signal output by the first transmission device or a signal based upon this signal output by the first transmission device. Furthermore, the transport path of the containers runs between the transmission device and the receiving device.

According to the invention, the inspection device has a second transmission device which outputs a high-frequency transmission signal and a second receiving device which receives the signal output by the second transmission device or a signal founded or based upon this signal output by the second transmission device, wherein the second transmission device is offset from the first transmission device in a longitudinal direction of the containers to be inspected, and the second receiving device is, or is arranged, offset from the first receiving device in a longitudinal direction of the containers to be inspected.

It is therefore also proposed with regard to the method that preferably two measuring sections or at least two measuring sections be constructed, which each serve to determine the fill levels. Particularly preferably, a measured value is determined for at least one measuring section and particularly preferably for both measuring sections, which is characteristic of an electric field that is characteristic between the transmission and receiving devices of these measuring sections or the electric fields.

Particularly preferably, at least one value influencing the measurement is taken into account and in particular compensated for. This value can, for example, be environmental conditions such as pressure, temperature, or humidity. Furthermore, this value can also be influences from neighboring containers (which in particular influence the electric field).

In a further preferred embodiment, the electric field or the value characteristic thereof is determined continuously. In this way, for example, a periodically fluctuating characteristic can arise. Particularly preferably, an output signal of at least one receiving device is evaluated. For example, an amplitude and/or a phase can be taken into account.

In a further preferred method, artificial intelligence is used to evaluate the output signal.

For example, it is possible to record and save a plurality of signal curves. These can preferably be compared with an actually measured fill-level value or an actually measured signal characteristic.

In this way, an artificial neural network can preferably be trained. More specifically, it is possible to annotate typical signal characteristics of the antennas and/or receiving devices with the actually measured fill-level value and therefore train an artificial neural network.

The signals for each container resemble an inverted Gaussian function.

The measurement of the signal of the receiving device is preferably carried out continuously, in particular also when no container is moving through the measuring device or measuring bridge. A container that passes through the measuring bridge is preferably recognized, and, particularly preferably, the measurement data thereto are then saved.

It is possible for an (external) light barrier to be provided for triggering. Preferably however, internal triggering is provided. Preferably, an (internal) light source, in particular an (internal) IR diode, is provided for this purpose, which is preferably additionally installed in a hardware.

In a further preferred method, the measurements are carried out simultaneously with different frequencies or time-staggered (preferably with different frequencies) (for example, with a multiplexing method).

In a further preferred method, a pair of a transmission device and a receiving device is used per measurement. However, it would also be possible to multiplex receiving devices and transmission devices, or to also assign several receiving devices to one transmission device.

In a further preferred method, the containers are transported at a transport speed that is greater than 0.2 m/s, preferably greater than 0.3 m/s, preferably greater than 0.4 m/s, and particularly preferably greater than 0.5 m/s. Preferably, the containers are transported at a transport speed that is less than 5 m/s, preferably less than 4 m/s, preferably less than 3 m/s, and particularly preferably less than 2.5 m/s.

In the context of this disclosure, a high-frequency signal is understood to mean in particular a signal with a frequency of more than 1 MHz, preferably more than 2 MHz, and particularly preferably more than 3 MHz.

The apparatus and the method described here are inexpensive to purchase and operate, and avoid safety-critical aspects such as ionizing radiation. In addition, the apparatus and the method can also be used when labels cover the fill level.

Preferably, an analog fill-level measurement is carried out which is preferably linear over a measuring range between 30 and 100 mm. In addition, robust measurement is possible despite height tolerances of the containers, of larger fill-level fluctuations, and tolerances in the height adjustment of the sensors.

Further advantages and embodiments can be seen in the accompanying drawings, in which:

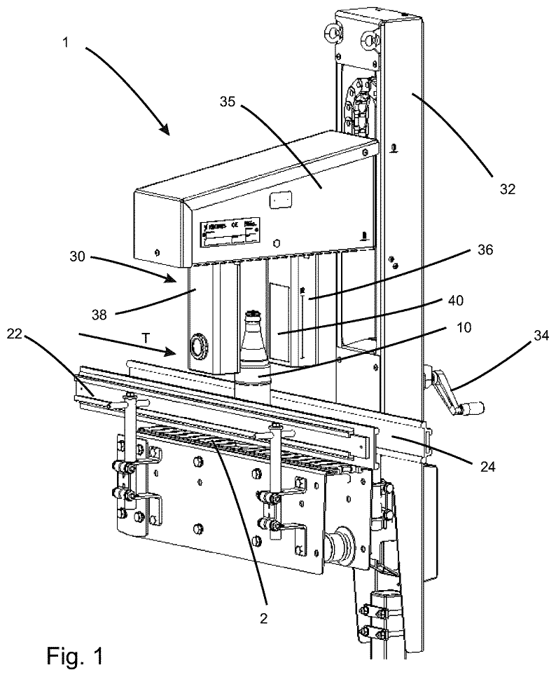

FIG. 1 shows a schematic representation of an apparatus according to the invention;

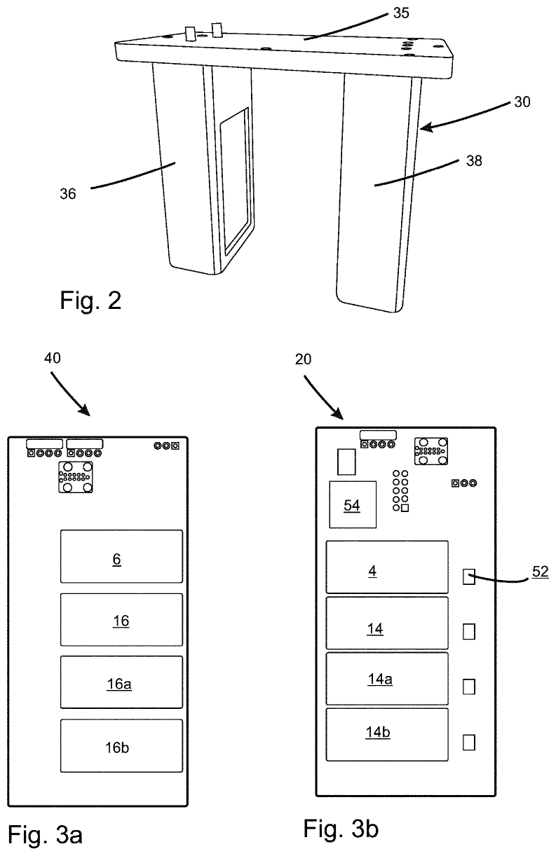

FIG. 2 shows a representation of an inspection device;

FIG. 3a shows a representation of an arrangement with a plurality of receiving devices; and

FIG. 3b shows a representation of an arrangement with a plurality of transmission devices.

FIG. 1 shows a representation of an apparatus 1 according to the invention. This has a transport device 2 in the form of a conveyor belt or a transport chain which serves to transport the containers 10 in the transport direction T. Reference signs 22 and 24 identify two guide rails which guide the transport movement of the containers 10. As can be seen in FIG. 1, the containers are preferably filled, closed containers. These containers can be labeled or printed.

Reference sign 32 designates a carrier to which an arm 35 is attached, which in turn carries the inspection device designated as a whole by 30. Reference sign 34 designates an adjustment device with which a height position of the arm 35 and therefore also the inspection device 30 can be changed.

Reference sign 36 designates a first carrier, and reference sign 38 designates a second carrier. These carriers are used to accommodate the transmission devices and receiving devices. Reference sign 40 designates the receiving arrangement which is arranged on the carrier 36.

FIG. 2 shows a representation of an inspection device 30. Here again, the two arms 36 and 38 are visible, as well as a cross member 35 on which these arms 36, 38 are arranged.

FIG. 3a shows a representation of a receiving arrangement 40. A total of four receiving devices 6, 16, 16a, and 16b are arranged here. It can be seen that these are arranged one above the other and, in particular in an assembled state, are arranged one above the other in the longitudinal direction of the containers. The individual receiving devices preferably have a plate-like shape.

FIG. 3b shows a corresponding transmission arrangement 20. This has 4 transmission devices 4, 14, 14a, and 14b. These are each controlled by control devices 52. Electric fields can be established between the individual transmission devices 4, 14, 14a, and 14b and the receiving devices 6, 16, 16a, and 16b. Reference sign 52 designates a control device which controls these fields and/or the transmission devices. Reference sign 54 denotes a processor device which controls the entire transmission arrangement. This processor device can also take over the evaluation of the recorded signals.

The containers 10 are transported between these individual transmission and receiving devices, and in particular by the electric field established between these transmission and receiving devices. By determining this electric field, the fill level of the container can be monitored.

It is conceivable that these electric fields fluctuate-for example, depending upon whether there is a container between the transmission and receiving devices or an empty space between two containers. Preferably, corresponding measurement curves are recorded over a longer time. If a container with an improper fill level passes through the gap between the transmission and receiving devices, this will be apparent from the respective output signal. Accordingly, an ejection device (not shown) can then eject the incorrectly filled container.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for monitoring the fill level of filled containers, having a transport device which is configured to transport the containers along a predetermined transport path, and having an inspection device configured for inspecting the containers transported by the transport device, wherein the inspection device has a first transmission device which is configured to output a high-frequency transmission signal and a first receiving device which is configured to receive the signal output by the first transmission device or a signal based upon this signal output by the first transmission device, wherein the transport path of the containers runs between the transmission device and the receiving device,
wherein
the inspection device has a second transmission device which is configured to output a high-frequency transmission signal and a second receiving device which is configured to receive the signal output by the second transmission device or a signal based upon this signal output by the second transmission device, wherein the second transmission device is arranged in an offset manner in a longitudinal direction of the containers to be inspected relative to the first transmission device, and the second receiving device is arranged in an offset manner in a longitudinal direction of the containers to be inspected relative to the first receiving device.

2. The apparatus according to claim 1,
wherein
each transmission device is assigned exactly one receiving device in such a way that this transmission device and the receiving device assigned thereto form a measuring path.

3. The apparatus according to claim 1,
wherein
at least one transmission device and the receiving device assigned thereto are arranged in such a way that an electric field is established between this transmission device and the receiving device assigned thereto, through which the containers can be transported.

4. The apparatus according to claim 1, wherein
the transport path is rectilinear, and preferably at least one guide device is provided for guiding the containers, which limits a movement of the containers perpendicular to the transport path.

5. The apparatus according to claim 1, wherein
the inspection device has at least one further transmission device which is configured to output a high-frequency transmission signal and at least one further receiving device which is configured to receive the signal output by the further transmission device or a signal based upon this signal output by the further transmission device, wherein the additional transmission device is arranged in a longitudinal direction of the containers to be inspected in an offset manner from the first transmission device and the second transmission device, and the further receiving device is arranged in the longitudinal direction of the containers to be inspected in an offset manner relative to the first receiving device and the second receiving device.

6. The apparatus according to claim 1, wherein
all transmission devices are arranged on a first side laterally next to the transport path, and all receiving devices, with respect to the transport path, are arranged on a second side opposite the first side next to the transport path.

7. The apparatus according to claim 1, wherein
the inspection device has a bridge-like carrier on which the transmission devices and the receiving devices are arranged.

8. The apparatus according to claim 1, wherein
the inspection device has at least one measuring device which is configured to measure a value characteristic of an electric field between a transmission device and the receiving device assigned thereto.

9. The apparatus according to claim 1, wherein
several transmission devices is configured to be operated simultaneously, wherein these transmission devices are configured to be operated with different transmission frequencies.

10. The apparatus according to claim 1, wherein
the apparatus has a control device which is configured to enable a time-staggered activation of several transmission devices and preferably also of the receiving devices assigned to these transmission devices.

11. The apparatus according to claim 1, wherein
the inspection device forms a measuring range in the longitudinal direction of the containers which is larger than 20 mm, preferably larger than 40 mm, preferably larger than 60 mm, and particularly preferably larger than 70 mm, and/or the inspection device forms a measuring range in the longitudinal direction of the containers which is less than 130 mm, preferably less than 120 mm, preferably less than 110 mm, and particularly preferably less than 100 mm.

12. The apparatus according to claim 1, wherein
the apparatus has a sensor device configured for detecting at least one value characteristic of environmental conditions and preferably a processor unit which is configured to take this characteristic value into account when evaluating measured values originating from the at least one measuring section.

13. A method for monitoring the fill level of filled containers, wherein a transport device transports the containers along a predetermined transport path, and an inspection device inspects the containers transported by the transport device, wherein the inspection device has a first transmission device which outputs a high-frequency transmission signal and a first receiving device which receives the signal output by the first transmission device or a signal based upon this signal output by the first transmission device, wherein the transport path of the containers runs between the transmission device and the receiving device,
wherein
the inspection device has a second transmission device which outputs a high-frequency transmission signal and a second receiving device which receives the signal output by the second transmission device or a signal based upon this signal output by the second transmission device, wherein the second transmission device is arranged in an offset manner in a longitudinal direction of the containers to be inspected relative to the first transmission device, and the second receiving device is arranged in an offset manner in a longitudinal direction of the containers to be inspected relative to the first receiving device.

14. The method according to claim 13,
wherein
at least one value influencing the measurement is taken into account and in particular compensated for.

15. The method according to claim 13, wherein
the measurement signals from the receiving devices are evaluated using artificial intelligence.

16. The apparatus according to claim 2, wherein
the transport path is rectilinear, and preferably at least one guide device is provided for guiding the containers, which limits a movement of the containers perpendicular to the transport path.

17. The apparatus according to claim 2, wherein
the inspection device has at least one further transmission device which is configured to output a high-frequency transmission signal and at least one further receiving device which is configured to receive the signal output by the further transmission device or a signal based upon this signal output by the further transmission device, wherein the additional transmission device is arranged in a longitudinal direction of the containers to be inspected in an offset manner from the first transmission device and the second transmission device, and the further receiving device is arranged in the longitudinal direction of the containers to be inspected in an offset manner relative to the first receiving device and the second receiving device.

18. The apparatus according to claim 2, wherein
all transmission devices are arranged on a first side laterally next to the transport path, and all receiving devices, with respect to the transport path, are arranged on a second side opposite the first side next to the transport path.

19. The method according to claim 14, wherein
the measurement signals from the receiving devices are evaluated using artificial intelligence.
